(19) United States
(12) Patent Application Publication
(10) Pub. No.: US 2025/0067338 A1
(43) Pub. Date: Feb. 27, 2025

(54) Adaptive Signaling

(71) Applicant: Axel Rietschin, Sammamish, WA (US)

(72) Inventor: Axel Rietschin, Sammamish, WA (US)

(73) Assignee: RIETSCHIN TECHNOLOGY LICENSING, LLC, Sammamish, WA (US)

(21) Appl. No.: 18/141,443

(22) Filed: Apr. 30, 2023

(51) Int. Cl. F16H 61/02; F16H 59/00; F16H 61/24; G08B 7/06

(52) U.S. Cl. CPC F16H 61/0213; F16H 61/24; G08B 7/06; F16H 59/00; F16H 2059/003; F16H 2061/248

(57) ABSTRACT

The invention presented herein solves the problem of sending a signal or alert ahead of time with sufficient advance notice in order for an operation or action to be carried as close as possible to a pre-determined point, either by one or more operators or by automated systems. The invention learns and factors in the total reaction time of the system and evaluates dynamic conditions to improve its predictions over time. The invention also presents an apparatus that conveys the signal or alert to one or more operators in a simple and effective way.

### BACKGROUND OF THE INVENTION

In a system where an action or change must be performed in a timely manner as a function of some variables, a signal or alert is sent to initiate said action or change. The system has a response time that can be fixed or which varies as a function of some variables. The response time may be composed of multiple parts. If, for example, a living operator is involved, the system's response time is composed of the operator's reaction time plus any systemic lag. In order for the action to be carried on at the expected point, the signal must be sent ahead of time with sufficient anticipation to account for the system's response time. Moreover, the anticipation time that is required to carry out the operation at the expected point varies dynamically as a function of the rate of change in the state of the system. For example, if the variables prompting the action evolve rapidly, the signal anticipation must increase appropriately to account for the rapid evolution.

### SUMMARY OF THE INVENTION

The invention presented herein consists of a method that learns from observations of the system's state and from observations of the response time to the signal sent to carry an operation to dynamically adapt the anticipation time which must be introduced in order for the operation to be consistently performed at the expected point, and of an apparatus that can be used to effectively convey the signal to one or more operators of the system.

### BRIEF DESCRIPTION OF DRAWINGS

FIG. 1—Partial representation of the sound wave used for the auditory signal.

### DETAILED DESCRIPTION OF THE INVENTION

What follows is an exemplary embodiment that illustrates one possible use of the invention. The embodiment pertains to a domain where the benefits of the invention would be substantial but shall not be construed as a limitation of the scope of applicability of the invention.

Described herein are an apparatus and strategy used to convey timely gear-shifting indications to the driver or the automated or semi-automated gear change system of a vehicle equipped with a multi-gear transmission.

The challenges to overcome include the clear, simple, and judicious signaling of the gear-shifting instructions to the driver or the automated or semi-automated gear change system to optimize the use of the engine's power band.

Existing solutions use a single indicator light or symbol that appears, illuminates, blinks, or flashes to signal the driver that it is time to change gears. Other schemes include multiple lights or symbols forming a “ramp” or some other geometric construction, sometimes composed of different colored segments, that progressively light up following some pattern to inform the driver of the upcoming gear change point.

Existing solutions sometimes also give the driver an indication of the engine speed and sometimes of its progression, together with an indication of the moment the shift should occur, leaving it to the driver to estimate in advance when this instant is supposed to happen and anticipate that moment. This leads to inconsistent results and frequent overshoots of the ideal shift points and requires additional attention from the driver.

While competing or driving sportively, the driver's attention is focused on the road ahead and on other vehicles or obstacles that may be present on the road or track. Bright lights flashing in various patterns and changing colors before their eyes can be distracting.

On many occasions, the driver's focus is not straight ahead of the vehicle, for example, during cornering or traffic situations. The gear change indicator (sometimes described as “shift light”) is usually either on the dashboard or the steering wheel, or steering device, or the handlebar facing the driver, while the driver might be looking at an angle or sideways. Save for straight-line driving, the indicator is rarely centered in the field of view of the driver.

The embodiment presented here proposes a simplified visual indicator composed of only two indicators with specific and distinct functions and specific colors, augmented with haptic and acoustic signaling methods.

The system factors the current engine acceleration (i.e., the rate of change of engine speed over time) and the learned driver reaction time (or the automated or semi-automated gear change system latency) as well as any systemic latency to convey the gear change signal ahead of time with sufficient advance notice, tailored for each gear and each driver or automated gear change system, making it easier for the drivers or automated gear change systems to repeatedly and consistently hit the expected gear change points.

The system described here is not concerned with the determination of the optimal gear shift points themselves but mainly with the mechanisms to timely convey the signal to the driver or the automated or semi-automated gear change system in the most efficient and less disruptive way, factoring the time required to act (i.e., reaction time or latency of both the driver and the gear change actuation system) and the current engine speed acceleration to convey the instruction to the driver or the automated or semi-automated gear change system ahead of time.

The system incorporates self-learning abilities to adapt the gear change signal anticipation to the actual driver or the automated or semi-automated gear change system reaction time or latency plus any systemic latency and the observed capabilities of the vehicle, which evolve as the vehicle gets lighter over the course of an event as fuel gets consumed.

The vehicle acceleration (seen from the engine's perspective as the rate of change of the engine's rotation speed in a particular gear) is affected by numerous factors other than the current gear and vehicle weight.

The slope of the road, where the acceleration rate is higher going downhill than uphill due to the effect of gravity, or the position of drag reduction systems affecting the vehicle's aerodynamics, as well as the state of hybrid assistance systems the vehicle may have, such as heat or kinetic energy recovery systems, electrically-assisted turbochargers, or any future system providing a temporary acceleration “boost” above the baseline provided by the main engine, all affect the time the driver or the automated or semi-automated gear change system has to perform the gear change from a given gear to the next in time, and therefore affect the anticipation the system must introduce into the signaling.

The signal also instructs the driver or the automated or semi-automated gear change system to shift down (i.e., engage a lower gear) at a set engine speed for each gear, with the required anticipation, if the engine speed is about to go lower than the set limit and requires engaging a lower gear.

The downshift signal is helpful to avoid engine speed “stacking up” when the driver downshifts in quick succession without slowing the vehicle enough in between gear changes, potentially resulting in over-revving the engine.

The downshift signal makes it easy for the driver or the automated or semi-automated gear change system to accurately maintain the engine within its power band when decelerating. The dynamic nature of the system adapts to the current engine speed deceleration and adjusts the anticipation of the signal accordingly.

Finally, the signal conveys to the driver that the engine is operating at its maximum speed (i.e., rev limiter.)

This system applies equally well to vehicles where the driver or operator changes the gears manually than to vehicles equipped with an automatic or semi-automatic transmission and continuously variable transmissions (CVT) that simulate discrete gears.

While the visual, haptic, and auditory signals mainly apply to manually operated transmissions, the same reaction time (or latency) learning and engine-acceleration-based time anticipation applies to automatic or semi-automatic transmissions.

### Visual Signal

The normal state of the visual signal is OFF while driving in the correct RPM range. When the engine speed decreases and is about to go below a certain set threshold for each gear, the down-shift indicator appears or illuminates for as long as the condition for its appearance exists. When the engine speed increases and is about to reach the next shift point, the up-shift indicator appears or illuminates for as long as the condition for its appearance exists.

The indicator can assume any shape. For example, it can be round, rectangular, shaped like arrows, text, or any other shape. It can be a stand-alone device or integrated into another device, such as a dashboard, steering wheel, or steering device.

It can be made of two distinct indicators or regions of one or more display screen(s) or a single indicator or part of the same screen, where the signal's color, shape, or appearance varies to convey the intended message.

The display described here is only one amongst many possible embodiments and consists of two rectangularly shaped visual indicators that could be implemented by LEDs or rectangular groups of pixels on a display screen.

In this embodiment, the indicator is split into two regions: the left-hand region illuminates in the “amber” color to request a down-shift from the driver. The right-hand region lights in a “green” tint to request an up-shift from the driver.

Note: On steering wheels/devices equipped with “paddle shift” controls, the most common layout across the automobile and motorsport industries is to assign the down-shift function to the left-hand paddle while the up-shift function is assigned to the right-hand paddle. The indicator described here to illustrate a possible embodiment follows the same convention.

The range of colors qualifying as “amber” in the context of this embodiment is formally defined in SAE standard J578, section 3.1.2.

The range of colors qualifying as “green” in the context of this embodiment is formally defined in SAE standard J578, section 3.1.4.

The two color ranges are specifically chosen to convey the intended signal in a non-obtrusive way. Amber colors convey a mild call-to-action, while green colors send a strong “go ahead” signal, and neither is perceived as alarming, an essential point from a driver's psychology perspective.

The brightness level of each of the lights (Amber and Green) are set so their luminance matches: the apparent brightness of both light sources is set so they appear equal to the human eye. For that, they follow the spectral sensitivity of the eye, which peaks in the green region. As such, the amber light requires more energy than the green light to appear of equal brightness to the driver.

The amount of emitted visible light energy can be measured directly through a device known as a luminance and color meter (e.g., a Konica Minolta CS-150 Luminance and Color Meter, or equivalent) and then subjectively adjusted, if necessary, in order for both signals to appear of equal apparent brightness to the eye.

The mentioned luminance and color meter is described as possessing a “spectral responses that more closely match[es . . . ] the sensitivity of the human eye.” More information about this device can be obtained from Konica Minolta Sensing Americas Inc, of Ramsey, NJ.

LEDs are driven by a pulse-width-modulated (PWM) signal whose frequency and duty cycle determine the amount of energy fed to the light-emitting diode, which in turn controls the amount of emitted light energy. When a digital display is used, the pixel brightness can be adjusted independently for the two signals to adjust the relative brightness of the two-color indicator, so they appear equal.

The system can store linearization curves to maintain the correct (equal) relative brightness of the two signals when dimming or brightening the display to adapt its visibility to ambient lighting conditions.

The signals illuminate and stay ON for as long as the condition for illumination is satisfied. The over-rev (engine speed limiter) signal is one exception, where the up-shift signal blinks rapidly and repeatedly until the condition disappears to reinforce the importance of the action to be taken.

The signal has a hysteresis switching function, introducing a difference between the switch and reset points. For example, if the up-shift switch point is 10,000 RPM (i.e., rotations per minute) and the hysteresis value is 250 RPM, the light switches ON at some RPM value below 10,000 RPM in time for the driver to change nearly exactly at 10,000 RPM and stays on until the engine speed goes back down below 9,750 RPM.

Similarly, if the down-shift switch point is set to 7,500 RPM, the down-shift indicator turns on when the engine speed is about to fall below 7,500 RPM and stays ON until the engine speed is back above 7,750 RPM, assuming the same hysteresis value is used for both limits.

The hysteresis value can be adjusted (i.e., “calibrated”) in the device for both up-shift and down-shift independently, either as a scalar value (e.g., 250 RPM) or as a factor or percentage (e.g., 0.1, or 10%) of the set point engine speed.

The role of the hysteresis function is to prevent unwanted blinking or flickering of the signal when the engine speed value is noisy and oscillates near the switch point, possibly crossing the switch point back and forth several times in a short period.

The display adapts its brightness to the ambient light condition through an ambient light sensor, illuminating brighter in bright daylight to maintain visibility and dimming itself in the dark to avoid impairing the driver's vision.

When implemented as discrete lights, the light sources in this particular embodiment are in matte (diffused) surfaces and generally of medium intensity to avoid blinding the driver with a powerful and narrow-focused “point” light source, but they could be of any nature in different embodiments.

On a race vehicle, the downshift signal (amber) is typically lit most of the time when the driver is operating the vehicle below the engine's power band, for example, on the pit lane, during out-laps to cool down the vehicle, or on road sections in a Rallye.

On a street vehicle, the amber downshift signal is deactivated in “normal” drive mode and only becomes active in “sport” or “track” modes or equivalent, and only after the driver increases the engine speed above the downshift threshold plus its hysteresis at least once.

To limit distractions, the down-shift indicator can be disabled when the vehicle is in neutral or park or the lowest gear. Similarly, the up-shift and/or the over-rev indicator can be disabled when the vehicle is in the highest gear. This is particularly important as it avoids distracting the driver when the vehicle reaches its top speed.

Haptic alert for up-shifts and over-rev (wired or wireless)

The effectiveness of the signaling system is augmented by adding one or more haptic transducers conveying a physical stimulus to the driver.

One or more transducers can convey the haptic signal that generates perceptible vibrations and is in direct or indirect physical contact with the driver. The vibration frequency is in the 50 Hz to 200 Hz range.

One embodiment would be one or more transducer(s) mounted inside a helmet conveying a vibration to the maxillary bone, the cheekbone, the mastoid bone behind the ear, or any other appropriate location or combination of locations.

The locations are chosen to convey the vibration to the auditory duct in addition to the physical stimulus at the point of contact of the transducers, making the signal conveying effective and unmistakable even in a very noisy and stressful environment.

The transducers can also be incorporated into the steering wheel or device or the gear change actuation controls to send the signal through one or both of the driver's hands or fingers. The driver can choose the pitch and intensity of the haptic signal.

The haptic alert generally mirrors the up-shift visual signal as far as its activation: it turns ON at about the same time as the visual indicator turns ON. The haptic signal, however, only stays on for a short time, less than 1 second.

A particular signal, a series of short bursts, conveys the over-rev condition where the driver must change gears. The signal persists until the condition disappears and mirrors the blinking of the visual cue.

The haptic transducers and their support circuits can be wired or wireless. For example, the start signal for the haptic alert can be transmitted wirelessly over the air, in which case the wireless signal latency is independently considered in calculating the haptic alert signal anticipation.

The intrinsic latency of the haptic transducer itself is also factored in. Some haptic transducers are made of a small electric motor with an eccentric mass causing vibrations when the motor spins. Others are linear resonant actuators or piezo-electric actuators and vary in response time.

Some haptic transducers take time (lag time and rise time) to accelerate from rest to their operating speed, where their action can be felt, introducing some systemic latency.

That time is added to the time anticipation required to convey the haptic signal meaning the haptic signal is triggered slightly ahead of the visual and auditory alerts to compensate for the motor's startup time.

Sources of haptic transducers suitable for use in this embodiment include Precision Microdrives, of London, UK, or TDK Corporation of America, of Livonia, Michigan, USA.

When using a wireless connection, a pairing system ensures the security of the transmission. One example would be Bluetooth pairing or a similar system.

Audio cue for up-shifts and over-rev (wired or wireless)

An audible sound alert further augments the signaling system. This auditory cue works in lockstep with the haptic and visual signals and generally mirrors the visual signal activation timing.

The frequency range for the acoustic signal falls in the range 250 Hz-8000 Hz as defined in MIL-STD-1472H 5.3.3.3.1, and is selected to not interfere with human voice, as specified in MIL-STD-1472H 5.3.1.2.1, over radio transmission or onboard direct or intercom communication between the driver and their co-driver or passenger(s).

The embodiment can monitor the ambient sound level using a sound pressure level metering device (for example, a microphone) or infers the sound level from the current gear and engine speed directly or through pre-stored ambient noise values for each gear and vehicle speed.

The sound level of the alert signal is at least 15 dBA above the ambient sound level but no louder than 140 dBP (peak) as per MIL-STD-1472H 5.3.2.1.3

The sound is percussive, with an attack of less than 0.1 seconds and a brief duration of less than 1.0 seconds to convey some level of urgency.

The default audio alert base frequency for this embodiment is 3532 Hz. The nature of the signal can be a sine wave, a square wave, or a combination of the two.

In this embodiment, the signal waveform is tailored to convey a high amount of average energy and consists of a square wave at the base frequency and 50% duty cycle, onto which a sine wave of much lower (and random) amplitude and several times higher frequency is superimposed by addition.

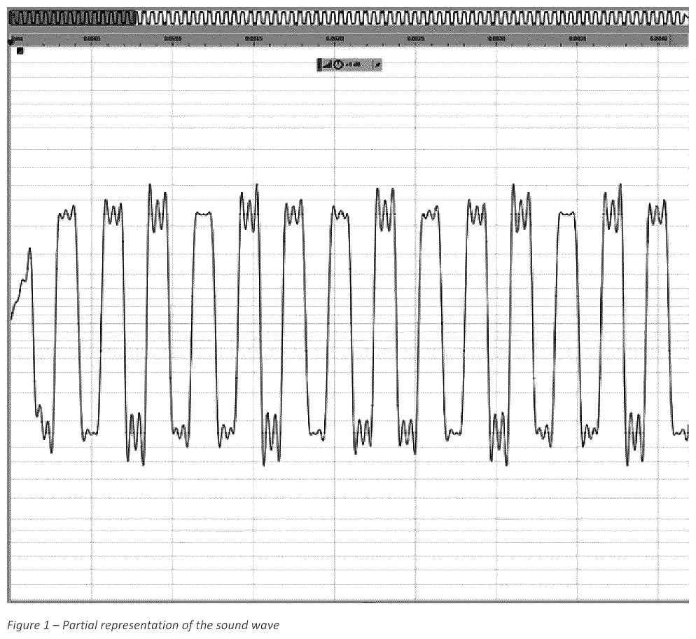

The result is a sound wave containing a high amount of energy without clipping or saturation, as illustrated in FIG. 1—Partial representation of the sound wave.

The default audio alert duration for this embodiment is about 23 milliseconds, including attack and decay times of about 225 microseconds to avoid audio “clicks” producing a crisp and unmistakable alert.

The audio cue is adjustable in volume, length, and pitch and, perceived by the driver, occurs in sync with the visual and haptic signals.

The audio cue can be conveyed through one or more speakers, earphones, “buzzers” of some form (also known as piezo-electric transducers), or any other sound reproduction device or device.

The audio transducers and their support circuits can be wired or wireless. For example, the audio start signal, or the audio signal itself, can be transmitted wirelessly over the air, in which case the wireless signal latency is independently taken into account in the calculation of the audio signal alert anticipation.

When using a wireless connection, a pairing system ensures the security of the transmission. One example would be Bluetooth pairing or a similar system.

### Engine and Vehicle Speed

The gear change signaling system receives the engine speed from a sensor. The sensor can be wired or wireless. The engine speed sensor can be connected directly to the signaling system or be transmitted by or acquired from another system, for example, the engine management system, and conveyed to the gear change signaling system, for instance, over a connection similar to the Controller Area Network (i.e., CAN bus) or equivalent.

The gear change signaling system also receives an indication of the currently engaged gear. If such information is unavailable, the gear change signaling system can infer the current gear from the engine speed, the vehicle speed, wheel diameter or rolling radius, and the gear and final ratios. To that effect, the gear change signaling system receives the vehicle speed either through a directly connected wired or wireless sensor, or that information can be transmitted by or acquired from another system on the vehicle.

The gear ratios and wheel diameter or radius can be calibrated into the system, typically with one ratio per gear and the final ratio and the rolling radius or diameter of the driven wheel or wheels.

Alternatively, the gear change signaling system can learn the total gear ratios by observing the vehicle speed and engine speed while the vehicle is driven in each gear successively for a few seconds each, simply by observing the correlation between the engine and vehicle speed. The system waits until the signal is stable (i.e., the two speed values are strongly correlated) for a second or so) then stores the learned ratio as one “gear” and keeps learning until all gear ratios have been discovered.

The gear change signaling system stores the learned ratios in descending order, where the first gear has the highest ratio between engine and vehicle speeds, meaning the ratios can be learned in any order.

Base driver reaction time or automated gear change system's latency

The gear change signaling system stores a base driver or automated or semi-automated gear change system reaction time or latency calibrated into the system and serves as a default for up and downshifts and each gear. The value is chosen as the default driver or automated or semi-automated gear change system reaction time or latency between the activation of the signal and the effective gear change.

Any value can be used as the default. However, in practice, the default is generally short, in the order of one second or less on a manually operated street vehicle, and could be as low as 100 milliseconds on a competition vehicle driven by a trained driver, or less in the case of an automatic or semi-automatic transmission.

In the case of automatic or semi-automatic transmission, the latency is determined by the time required to perform the gear shift.

On some vehicles, this time can vary from gear to gear depending on the construction of the gearbox, e.g., dual-clutch, robotized transmission, or any other mechanism.

Adaptive per-gear driver reaction time, automated gear change's latency

The gear change signaling system measures the effective shift time latency by timing the delay between the activation of the signal and the effective gear change for each gear.

The system then uses a configurable fraction of the difference between the base shifting time and the observed shifting time going into that gear to compute an error value that is the basis for modifying the shift anticipation time going to that gear.

The gear change can be observed by a drop or increase in engine speed not correlated with a decline or increase in vehicle speed, or a change in the currently engaged gear signal, when available, or through a signal marking the activation of the clutch mechanism or the actuation of the gear change control, lever, or pallet.

For example, say the base shift time going from first into second gear is calibrated by default into the gear change signaling system to be 200 milliseconds.

Say the observed gear change reaction time (or latency) for that particular driver or system going into that specific gear on this particular vehicle and conditions is 150 milliseconds.

The difference between the observed time and the base time is 150 [milliseconds] minus 200 [milliseconds]=−50 [milliseconds], meaning the driver or system is quicker to react than envisioned.

The system adapts the signal anticipation to closely match the driver's or gear change system's reaction time or latency.

Say the system has a calibrated learning gain, a positive multiplier <=1.0, of value 0.1. Therefore, the calculated correction is −50 [milliseconds] times 0.1=−5 [milliseconds].

The corrected shift time for that gear becomes 200 [milliseconds] plus (−5 [milliseconds])=195 [milliseconds], which is the new anticipation time stored and used going into second gear going forward.

Say that, later, the vehicle is in first gear again, and the driver shifts to the second gear 150 milliseconds after the signal is activated.

The new difference (or error) between the observed time and the previous corrected anticipation time is 150 [milliseconds] minus 195 [milliseconds]=−45 [milliseconds].

Applying the learning gain of 0.1, the calculated correction is −45 [milliseconds] times 0.1=−4.5 [milliseconds].

The new corrected shift time becomes 195 [milliseconds] plus (−4.5 [milliseconds])=190.5 [milliseconds], which is the new delay used going into the second gear from this point on.

The system adapts the anticipation time based on the observed reaction time or latency.

In the above example, if the driver consistently performs the first to second gear change 150 milliseconds after the signal activation, the default 200 milliseconds calibrated driver reaction time slowly converges towards the actual 150 milliseconds it takes the driver to react to the signal.

The speed of convergence is controlled by the magnitude of the learning gain, which in this example was 0.1, meaning the value converges at a pace equal to one-tenth of the observed error.

The convergence can be made faster or slower by changing the gain. By setting the gain to a small positive value close to zero, the convergence can be made very slow if desired.

If the learning gain is set to its maximum value of 1.0, the anticipation time goes from 200 milliseconds to 150 milliseconds in just one step: 150 [milliseconds] minus 200 [milliseconds]=−50 [milliseconds], and 200 [milliseconds] plus (−50 [milliseconds] times 1.0)=150 [milliseconds].

Formally, the learning gain is a positive scalar value that is part of the left-open interval (0-1]

The adaptive part described above is the P-term (i.e., the proportional term) of a classic Proportional-Integral-Derivative (PID) controller.

Other embodiments might use the other two terms, namely the I-term (i.e., the integrator) and the D-term (i.e., the derivative term), to enhance the convergence speed.

For example, when used with an automated or semi-automated gear change system, a small I-term can be used to compensate for long-term wear and tear affecting the performance of the gear change system. Similarly, the D-term can be used with a larger P-term to increase and optimize the convergence speed.

The gear change signaling system stores the learned values for each gear as a set which can be saved and recalled as a “driver preset” for each driver in case of manually operated transmissions.

The driver presets can be copied from one device to another, meaning a particular driver can reuse their presets later on a different vehicle.

Similarly, the learned values can be saved, exported, imported, and restored as a set on automated or semi-automated gear change systems.

The trend amongst multiple drivers can be observed to adapt the initial default values and make them closer to, say, the average observed over time and several drivers, making the default value better and the convergence towards each driver's reaction time quicker.

Similarly, the observed delays' consistency can drive the choice of the initial learning gain. If drivers tend to be consistent in their reaction time, the learning gain can be increased slightly to make the system converge and adapt faster.

On automated transmissions, the learning gain can be set to a higher value by default to make the system converge more quickly toward what is expected to be a relatively consistent latency.

The default reaction time can also be set to a value that closely matches the anticipated latency of the gear change system.

On some semi-automated gear change systems, the latency is clearly perceptible and in the order of a half second or so between the driver input and the actual gear change.

Such vehicles, despite the semi-automated nature of the gearchanges themselves, fully benefits from this embodiment if the driver's reaction time and the gear change system's latency are taken into account.

Similarly, vehicles equipped with automated gear change systems still benefit from the latency learning and automatic adaptations of this embodiment, despite the potential absence of any indication to the driver.

In addition, the system considers the latency of any wireless transmission system and any additional latency in the haptic system and “fires” the respective signals in time so they coincide as perceived by the driver and convey the gear change instructions in perfect synchronization.

### Predictive Signaling as a Function of Engine Acceleration

One of the aspects of the embodiment is the prediction of the needed anticipation time between the activation of the signal and the actual gear change operation.

The system knows the time it takes for the driver to perform the shifting action after the up-shift signal is activated. This time starts from a calibrated default driver or system reaction time that is successively refined, as described above.

The system also receives the current engine speed several times per second.

From the time interval and the observed engine speed differences, the system computes the current engine acceleration and can derive the time it will take, at the current rate, for the engine to reach a certain speed. Note: the engine's acceleration can be positive (i.e., its speed increases) or negative when its speed decreases.

If the driver's reaction time is known to be, say, 150 milliseconds going into a given gear, the system can compute how many RPMs the engine will gain or lose at the current acceleration rate during that time and compute at which RPM the signal must be activated for the shift, which happens 150 milliseconds later, to occur at the expected engine speed.

Say the engine's acceleration is observed to be 1000 RPM per second, meaning the engine speed increases by 1000 RPM every passing second.

Knowing the driver's reaction time is 150 milliseconds, the system can compute the engine speed at which the signal must be activated for the driver to shift on time.

In this example, the engine speed will increase by 1,000 [RPM per second] times 0.15 [second]=150 [RPM] during the driver or gear change system reaction time.

If the shift point is supposed to be 9,500 RPM, the signal must be activated at 9,500[RPM] minus 150[RPM]=9,350[RPM] for the change to occur at the expected engine speed, factoring the driver or system reaction time.

Additionally, since the system factors in the latency of the alert signals: the signal going, for example, to the haptic transducer could be sent slightly ahead of that point to compensate for any delay in activating the haptic motor.

If the haptic motor takes 50 milliseconds to spool up, the system adds that time to the driver's reaction time and sets its RPM threshold so it happens 150 [milliseconds] plus 50 [milliseconds]=200 [milliseconds] ahead of the shift point.

The haptic signal is activated immediately, and the system then waits 50 milliseconds for the haptic motor to spool up before starting the visual and audio cues for all signals to be perceived by the driver at or very close to the same time.

Similarly, any delay or latency in the transmission mechanism, such as a wireless connection to the audio or haptic transducers, is considered and adds to the anticipation.

The reaction time is learned for each gear, going up or down to it, and the engine acceleration is also computed at a high rate (multiple times per second), so the prediction and signal timing varies from gear to gear and from one instant to the next.

Also, the car accelerates faster, going downhill, for example. If the engine speed acceleration is 1,250 RPM per second instead of 1,000 in that same gear, the anticipation for the same 9,500 RPM shift point becomes 1,250[RPM per second] times 0.15 second=187.5 [RPM].

Therefore, the signal must be activated at 9,500 [RPM] minus 187.5 [RPM]=9,312.5[RPM] going to the same gear at that particular moment.

In the semi-automatic transmission case, the driver reaction time and the gear change system latency are added to form the total latency.

For example, if the driver's reaction time is 150 milliseconds and the gear change system latency going into a particular gear is 250 milliseconds, the total time taken into account is 150 [milliseconds] plus 250 [milliseconds]=400 [milliseconds] and the system computes the RPM at which the signal must be activated considering the current engine acceleration rate and the need to change gears at a given set point, knowing the total latency between the signal and the effective gear change will be 400 milliseconds.

Any additional latency in the signal transmission or due to the nature of the transducers is accounted for, and the system stages the signal emissions for each of the three signaling mechanisms to “fire” at the same instant, reinforcing the effectiveness of the signal.

In our 1,000 RPM per second engine acceleration example, the engine speed at which the signal must be activated is 400 RPM ahead of the gear change set point.

If a wireless audio signal has a latency of 20 milliseconds, the audio cue should be sent 420 RPM ahead of the shift point, while the visual cue is sent 400 RPM ahead if it has no intrinsic latency.

Separately, if a wireless haptic signal also has a latency of 20 milliseconds and the haptic motor has a startup time of 50 milliseconds, adding a total of 70 milliseconds of latency to the haptic signal, the haptic signal start event is separately sent 470 RPM ahead of the expected shift point, again in our 1,000 RPM per second engine acceleration example.

The vehicle gaining speed faces higher and higher resistance as it accelerates due to friction (i.e., aerodynamic drag, rolling resistance curve, and internal frictions), meaning the engine's acceleration rate diminishes naturally in every gear as the vehicle speed increases, more so in upper gears where the vehicle speed is high.

The rate can also decline due to the engine's power curve, the state of any hybrid power assistance system, the position of any moveable or adjustable aerodynamic appendices, and the amount of fuel and other consumables on board.

The deceleration rate also varies with the brake temperature, tire condition, onboard weight, track or road condition, and other factors.

By observing the instantaneous rate of engine speed change, the system infers the required anticipation to trigger the signals ahead of time at the appropriate instants, ensuring consistent gear changes regardless of conditions.

The calculations above use simple linear extrapolation, assuming the engine acceleration remains constant during the driver or system reaction time.

The system can incorporate more sophisticated calculations (for example, quadratic or cubic interpolation using three or more points) to more accurately predict how the engine speed might evolve in successive instants and compute more precise anticipation.

The instructions to be given to the driver are straightforward: the indicator is simple, and the meaning of the signals is unambiguous and unmistakable.

The motivation is that they are losing time when either signal is activated during competitive driving.

The system's effectiveness is measured solely by estimating the accuracy of the gear changes by comparing the difference between the desired gear change engine speed and the actual observed gear change engine speed.

This system is not concerned with determining the most optimal shift points but with the accurate execution of the gear changes at the set shift points in question.

The shift points are either programmed and stored in the system for each gear or communicated from an external source.

When the system is calibrated correctly and the learning phase is complete, the observed gear change engine speeds should be close to the expectations, and in general, the observed errors should be relatively small and more consistent over time than with existing shift light systems.

Overall, the system enables the execution of more accurate and consistent gear change points, allowing better use of the engine's power band.

1. A method that, by observation of the dynamic behavior of a system, sends signals initiating actions or changes to said system ahead of time in order for those actions or changes to be carried on at the expected point, accounting for the system's presumed reaction time and the rate of change in the relevant state of the system, and learns from the observed reaction time to improve its future predictions.

2. An apparatus that acts as a bi-color “up/down” or “plus/minus” indicator where
an amber-colored visual indicator indicates the “down/minus” direction; and
a green-colored visual indicator signals the “up/plus” direction; and
a haptic signal optionally complements the visual indicator; and
an auditory signal optionally complements the visual indicator; and
the transducer lags are factored in to ensure all signals are perceived simultaneously.
